(19) United States
(12) Patent Application Publication
(10) Pub. No.: US 2015/0193000 A1
(43) Pub. Date: Jul. 9, 2015

(54) IMAGE-BASED INTERACTIVE DEVICE AND IMPLEMENTING METHOD THEREOF

(71) Applicant: Egismos Technology Corporation, Newark, DE (US)

(72) Inventor: Di Sheng HU, Taipei City (TW)

(73) Assignee: Egismos Technology Corporation, Newark, DE (US)

(21) Appl. No.: 14/228,872

(22) Filed: Mar. 28, 2014

(30) Foreign Application Priority Data
Jan. 3, 2014 (TW) 103100200

(51) Int. Cl. G06F 3/01; G06F 3/0484; G06F 3/0488; G06F 3/00; G06F 3/0487

(52) U.S. Cl. CPC G06F 3/017; G06F 3/005; G06F 3/0487; G06F 3/04886; G06F 3/0484

(57) ABSTRACT

An image-based virtual interactive device and implementing method thereof is provided wherein a projection module is used to project an image-based virtual interactive interface. When the user operates in the range of the image-based virtual interactive interface, a photosensing module and a tracking module simultaneously sense and capture the characteristics of the user's limb movements, and an identification module determines whether an operating command has been performed. Once it is performed, the operating command is then sent to an electronic device to drive corresponding application programs so as to perform a corresponding action. In this manner, the user can directly conduct human-computer interaction with the electronic device merely through limb movement, without contacting a physical medium.

### BACKGROUND OF INVENTION

1. Field of the Invention

The present invention relates to an image-based virtual interactive device and implementing method thereof, more particularly to an image-based virtual interactive device and implementing method thereof for users to conduct touch-less human-computer interaction with an electronic device by sensing and capturing the characteristics of user's limb movements.

2. Brief Description of the Prior Art

In order to be easy to carry, the development of electronic products has a trend toward miniaturization. However, the products are often limited in their ease of manipulation and control due to their smaller size. Among known technologies, the touch screen technology provides a very good solution for direct human-computer interaction, in which a user touches icon buttons on a touch screen and the tactile feedback system of the screen drives devices coupling therewith according to stored programs. Furthermore, a Taiwanese Patent Gazette No. 1275979 has disclosed an open-type virtual input device that can project an input interface image of paired peripheral equipment, such as a virtual keyboard, to enable input operations for the users. Although the image of the screen can also be projected onto the input interface image, the virtual keyboard has to be projected simultaneously so as to be able to conduct operations. The other technologies associated therewith can be referred to the Taiwanese Patent Gazette Nos. I410860, I266222.

However, the above conventional technologies are only of the kind of touch type human-computer interaction, which means that the virtual keyboard can be used for text input only, and not for direct manipulation and control on the displayed images of the electronic device.

Furthermore, a Taiwanese Patent Gazette No. 201342135 has disclosed a mobile device and its screen that can be projected to the back side thereof to form a 3D image. As a result, the user can interact with the mobile device within the range of the 3D image. However, since it requires the user to hold the mobile device in his hands, this would easily lead to user's arm fatigue. Therefore, how to provide users a comfortable and a plurality of different types of human-computer interactions is a pending issue to be resolved.

### SUMMARY OF THE INVENTION

In view of the above problems, the main objective of the present invention is to provide an image-based virtual interactive device and an implementing method thereof for users to perform touch-less human-computer interaction with an electronic device by user's limb movements.

In order to achieve the above objective, the method for the image-based virtual interactive device of the present invention is to pair an electronic device through either a wired or a wireless connecting means and a projection module that is used to project the screen's image of the electronic device on a surface or the top of a physical plane so as to form an image-based interactive interface. When a limb portion of a user operates on the interactive interface, a sensing signal emitted from a light emitting unit of a photosensing module is blocked by said user's limb portion and is reflected toward a light receiving unit. Then, a tracking module can track a moving trajectory of the user's limb. Finally, an identification module calculates and determines whether an operation command has been performed or not. If yes, the operating command is sent to the electronic device to drive corresponding application programs which then perform the corresponding actions.

### DETAILED DESCRIPTION OF PREFERRED EMBODIMENTS

Please refer to FIG. 1 and FIG. 2. The image-based virtual interactive device 1 of the present invention comprises a central control module 10 for controlling the transmission of information among the modules of the image-based virtual interactive device 1; a connection module 11 that connects the central control module 10 to at least one electronic device 2, wherein the connecting means is a wired connection (such as USB) or wireless connection (such as ZigBee, Bluetooth or WiFi); an emission module 12 for receiving and emitting digital signals to the electronic device 2; a projection module 13 for projecting the digital signals from the electronic device 2 to the surface or the top of the physical plane 3 so as to form an image-based virtual interactive interface A1, wherein the projection colors of the image-based virtual interactive interface A1, the dimension of its range and the resolution can be controlled by the central control module 10; a photosensing module 14 comprising a light emitting unit 141 and a light receiving unit 142, wherein the light emitting unit 141 is capable of emitting a plurality of sensing signals and the light receiving unit 142 is capable of receiving the reflected sensing signals; a tracking module 15 comprising at least one camera unit 151 for capturing human's limb movements and gesture actions; and an identification module 16 for calculating and determining whether an operation command has been performed by the signals detected by the photosensing module 14 and the tracking module 15.

Please refer now to FIG. 2 and conveniently to FIG. 1. The connection module 11 is used to connect at least one electronic device 2 through a wired or a wireless connection means to the device of the present invention. In this embodiment, the connection is achieved through a wireless connection. If there is a plurality of electronic devices 2 such as Smartphone, Notebook and Tablet present in a localized space, the user can select the one that will be used with the device. After the connection has been ensured, the projection module 13 projects the screen contents of the electronic device 2 to the surface or the top of the physical plane 3 so as to form an image-based virtual interactive interface A1, i.e. a virtual screen. The light emitting unit 141 of the photosensing module 14 emits a plurality of sensing signals to the surface or the top of the physical plane 3 so as to form a photosensing area A2, wherein the sensing signals can be, but not limited to, invisible light such as infrared light or laser light. Furthermore, the tracking module 15 forms a tracking area A3 over the physical plane 3 with its camera unit 151, so as to capture the user's limb movements and the gesture motions within the tracking area A3.

Additionally, the intersection range among the image-based virtual interactive interface A1, the photosensing area A2 and the tracking area A3 is an effective identification area Z for the identification module 16 to calculate and determine whether an operation command has been performed. Furthermore, the relative positions among the projection module 13, the photosensing module 14 and the tracking module 15 can be adapted according to the difference of products design.

Please refer to FIG. 3. The light emitting unit 141 of the photosensing module 14 emits a sensing signal R toward the effective identification area Z. If not blocked, the sensing signal R is transmitted to the physical plane 3 and is reflected thereon. The sensing signal R is then received by the light receiving unit 142 which, for example, may be a charge-coupled device or a CMOS photosensing component. As shown in FIG. 4; when in operation, a gesture H of the user is located in the effective identification area Z thereby blocking the sensing signal R. The sensing signal R is reflected back along the original path and received by the light receiving unit 142. In this manner, after the sensing signal R is emitted from the light emitting unit 141, a time difference occurs between the reception of the light by the receiving unit 142 in the blocked and in the unblocked condition, and a time lag is created between the emission and reception of the sensing signal R.

Please refer to FIG. 5 and conveniently to FIG. 3. When in operation, the gesture H of the user happens in the effective identification area Z above the physical plane 3. In addition to the detection through the photosensing module 14, at least one camera unit 151 of the tracking module 15 also simultaneously captures the limb movements and the actions of the gesture H, i.e. continuous position characteristics and action variation characteristics such as, but not limited to, up, down, to the left and to the right, swinging, making a fist and drawing a circle with a single hand or both hands. The example shown in the figure is a user's gesture H of a down-movement. When the gesture H located above the icon buttons of the application programs in the image-based virtual interactive interface A1 moves down a certain distance from atop, a moving trajectory d is formed without any contact of the gesture H with the physical plane 3. As shown in FIG. 1, the time lag between the emission and the reception of the sensing signal R and the moving trajectory d of the gesture H are both calculated and identified by the identification module 16 to determine whether an operation command has been performed or not. If an operation command has been performed, the operation command is transmitted by the transmission module 12 to the electronic device 2 so as to drive corresponding application programs to perform associated actions. Please refer now to FIG. 6. After receiving the operation command, the electronic device 2 drives the corresponding application programs, such as a calculator program in this embodiment, and updates the displayed image of the image-based virtual interactive interface A1 simultaneously. In this way, the user can use the program and perform calculations. If the user wants to return back to the previous frame, a swinging gesture H (not shown) or other actions can be performed on the image-based virtual interactive interface A1.

Please refer to FIG. 7 and conveniently to FIG. 1 and FIG. 2. Now the implementing method of the image-based virtual interactive device 1 will be described. First, the image-based virtual interactive device 1 is connected to at least one electronic device 2 through a wired or a wireless connecting means by the connection module 11 (step S100). Then the projection module 13 projects an image-based virtual interactive interface A1 over the physical plane 3 (Step S110). Simultaneously, the light emitting unit 141 of the photosensing module 14 emits a plurality of sensing signals R (see FIG. 3). When the user performs operations on the image-based virtual interactive interface A1 the sensing signal R will be blocked by the gesture H (see FIG. 4) thereby reflecting it towards the light receiving unit 142 (Step S120). At least one camera unit 151 of the tracking module 15 captures continuous positions and action variations of the gesture H simultaneously, such as the moving trajectory d of the gesture H (see FIG. 5) (Step S130). Finally, the time lag between the emission and the reception of the sensing signal R and the moving trajectory d of the gesture H both are calculated and identified by the identification module 16 to determine whether an operation command has been performed or not (Step S140). If not, it means that the gesture H did not enter the effective identification area Z or that the action characteristics of the gesture H cannot be identified, and the operation command cannot be performed so that the transmission of the operation command is not performed (Step S150). Conversely, if an operation command has been performed, which means that the gesture H is in the range of the effective identification area Z and the position or the action characteristics of the gesture H can be identified, it is transmitted by the transmission module 12 to the electronic device 2, so as to drive corresponding application programs to perform actions (Step S160).

According to FIG. 8, the image-based virtual interactive device 1 of the present invention can further include a switching module 17, which is linked to the central control module 10, for switching to a different electronic device to connect to, or for switching to different modes of image-based virtual interactive interfaces. As shown in FIG. 9, the user can switch the image-based interactive interface A1 according to his own requirements, such as projecting only a virtual screen A11 for operation, or projecting only a virtual keyboard A12 for text input, or simultaneously projecting a virtual screen A11 and a virtual keyboard A12. The present invention provides users with a selection of diverse functions.

As shown in FIG. 10, when the projection frame required by the user exceeds the projecting range of one image-based virtual interactive device 1, two or more image-based virtual interactive devices (1, 1′) can be used to connect to the same electronic device 2 and project an assembled image-based virtual interactive interface A1 over the physical plane 3. In this way, the proportions of text, patterns or images of the image-based virtual interactive interface A1 can be enlarged, not only for easy viewing but also for increasing the range of the human-computer interaction area.

In summary, the image-based virtual interactive device and implementing method thereof of the present invention is connected to at least one electronic device through either a wired or wireless connecting means, and a projection module is used to project the screen image of the electronic device over a physical plane so as to form an image-based virtual interactive interface, wherein a user can use a switching module for switching to a different display mode of the image-based virtual interactive interface. When a gesture of the user operates on the image-based virtual interactive interface, a sensing signal emitted by a light emitting unit of a photosensing module is blocked by user's gesture and is reflected toward a light receiving unit, therefore a time lag between the emission and the reception of the sensing signal is created. Simultaneously, a tracking module comprising at least one camera unit captures continuous positions and action variation characteristics of the gestures, such as moving trajectories. Finally, the time lag between the emission and the reception of the sensing signal and the moving trajectory both are calculated and identified by an identification module to determine whether an operation command has been performed or not. If yes, the operation command is transmitted to the electronic device to drive corresponding application programs so as to perform actions. In this manner, the present invention applying the above method can effectively achieve the objective of providing an image-based virtual interactive device and the implementing method thereof to perform touch-less human-computer interaction with an electronic device with user's limb movements.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

### Symbol List of Constituting Components

1, 1′ image-based virtual interactive device

10 central control module

11 connection module

12 emission module

13 projection module

14 photosensing module

141 light emitting unit

142 light receiving unit

15 tracking module

151 camera unit

16 identification module

17 switching module

2 electronic device

3 physical plane

A1 image-based virtual interactive interface

A11 virtual screen

A12 virtual keyboard

A2 photosensing area

A3 tracking area

d moving trajectory

H gesture

R sensing signal

Z effective identification area

Step S100 connecting to at least one electronic device

Step S110 projecting an image-based virtual interactive interface

Step S120 emitting sensing signals and receiving the reflected sensing signals

Step S130 tracking the moving trajectory of gesture

Step S140 calculating and determining whether an operation command has been performed or not

Step S150 no transmission of operation command

Step S160 transmitting operation command to the electronic device

### BRIEF DESCRIPTION OF ACCOMPANYING DRAWINGS

FIG. 1 is a block diagram showing the structure of the hardware modules of the present invention.

FIG. 2 is a schematic view (1) showing the first embodiment of the present invention.

FIG. 3 is a schematic view (2) showing the first embodiment of the present invention.

FIG. 4 is a schematic view (3) showing the first embodiment of the present invention. FIG. 5 is a schematic view (4) showing the first embodiment of the present invention.

FIG. 6 is a schematic view (5) showing the first embodiment of the present invention.

FIG. 7 is the flow chart showing the implementation of the present invention.

FIG. 8 is a block diagram showing another structure of the hardware modules of the present invention.

FIG. 9 is a schematic view (1) showing another embodiment of the present invention. FIG. 10 is another schematic view (2) showing the other embodiment of the present invention.

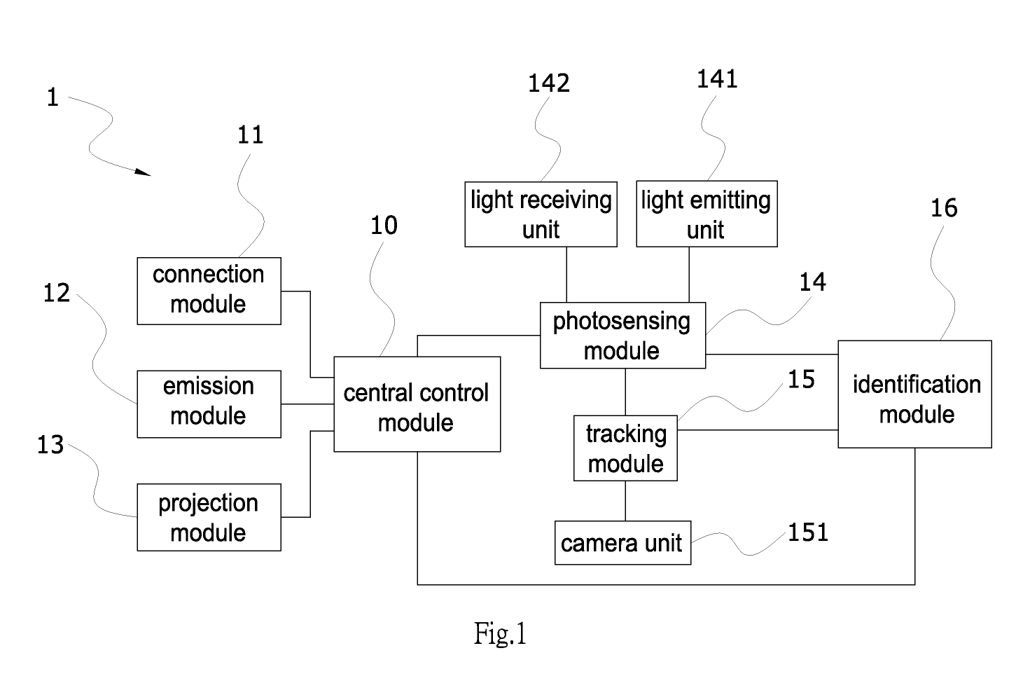

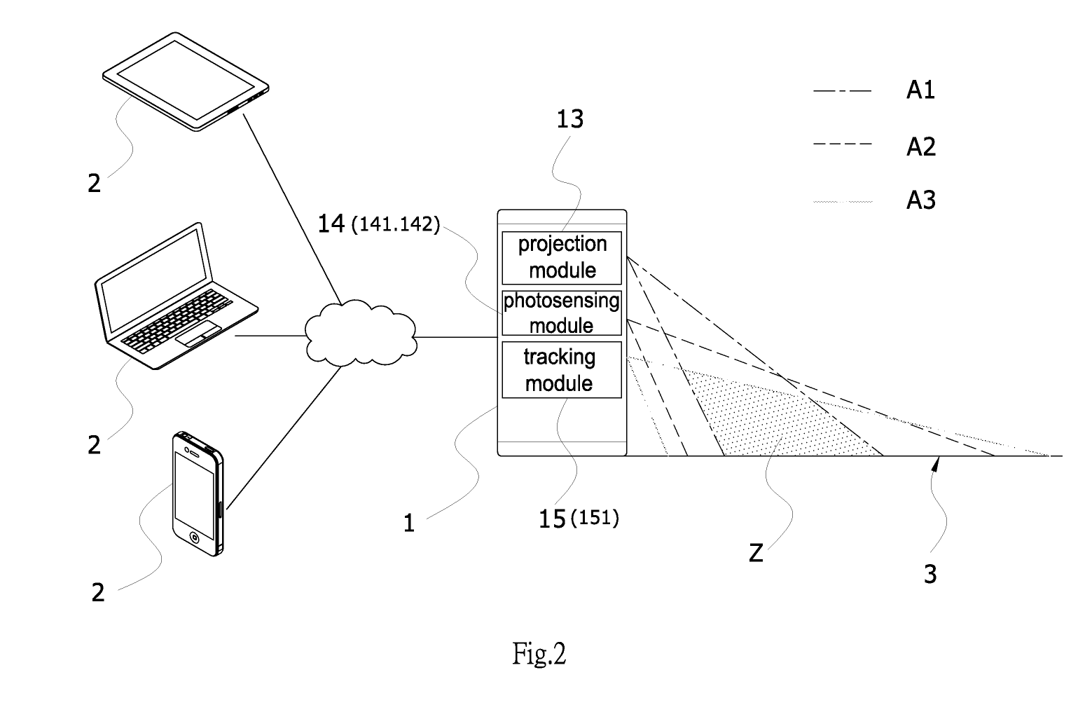

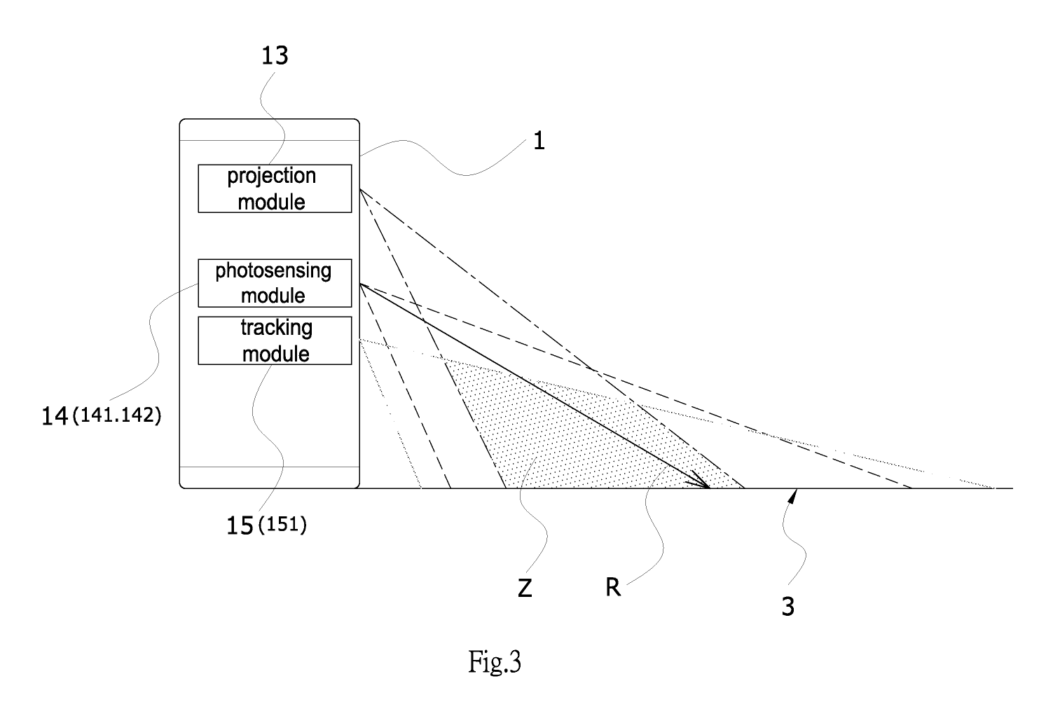

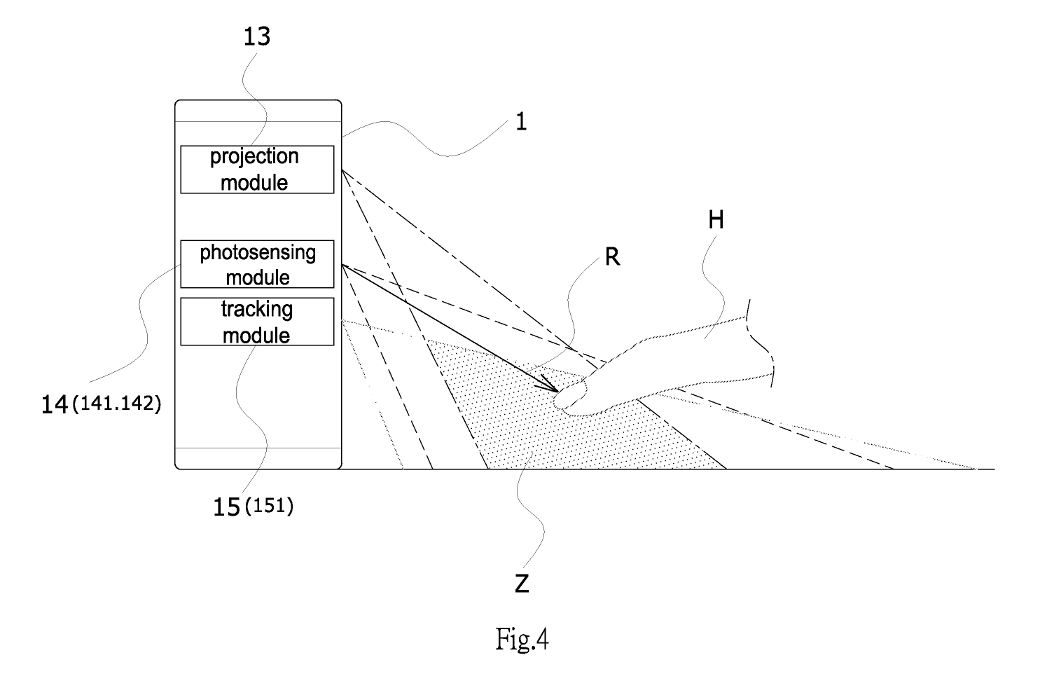

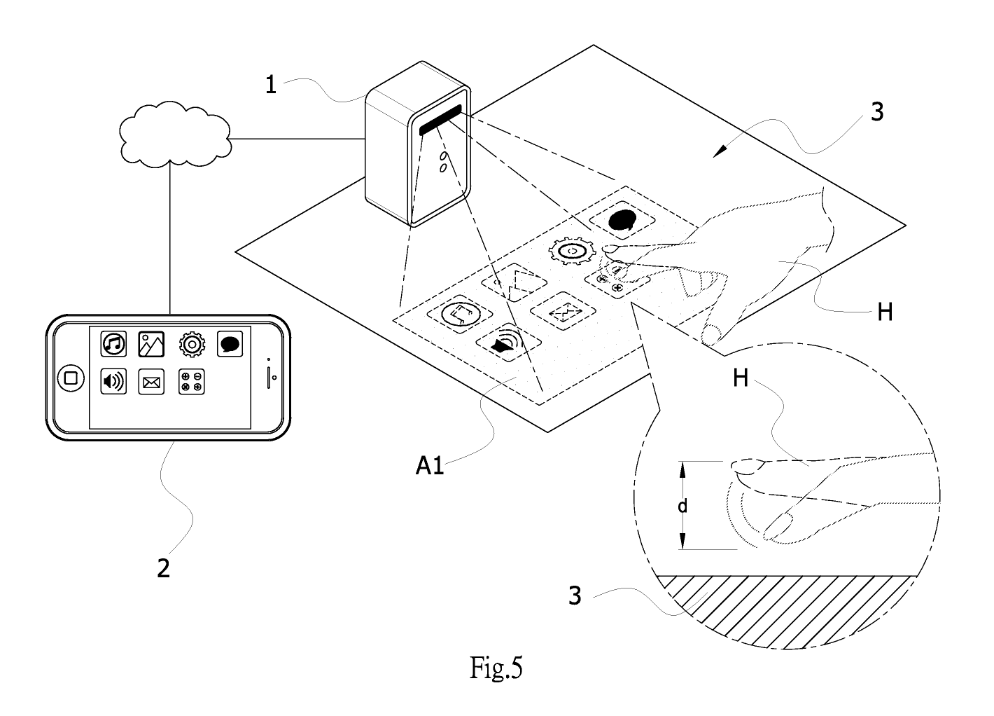

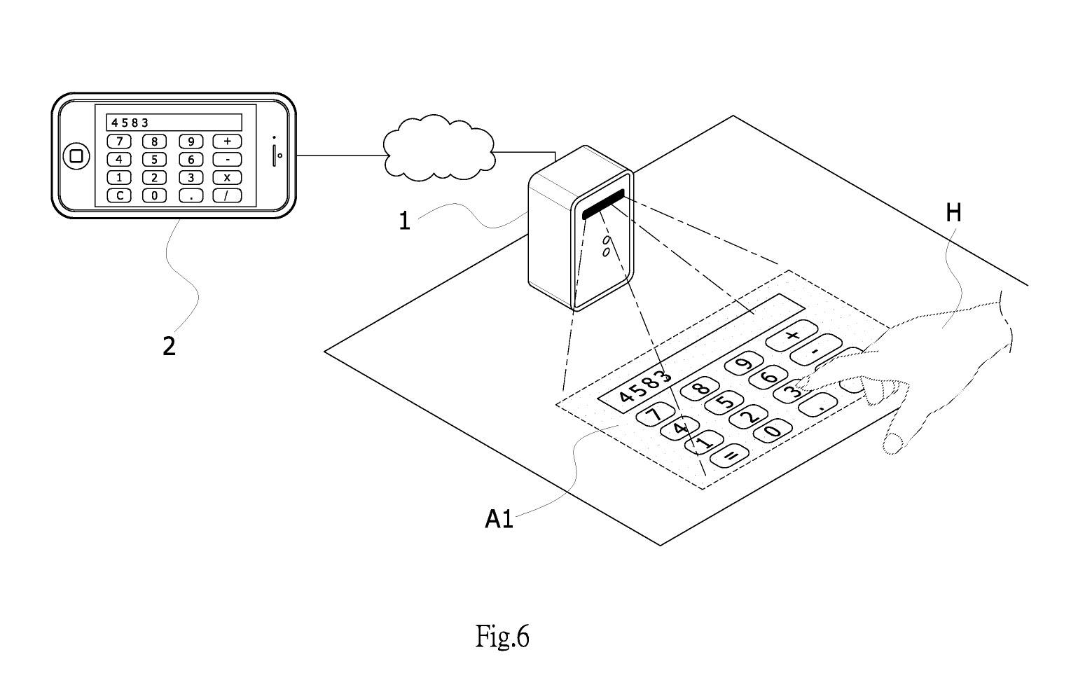

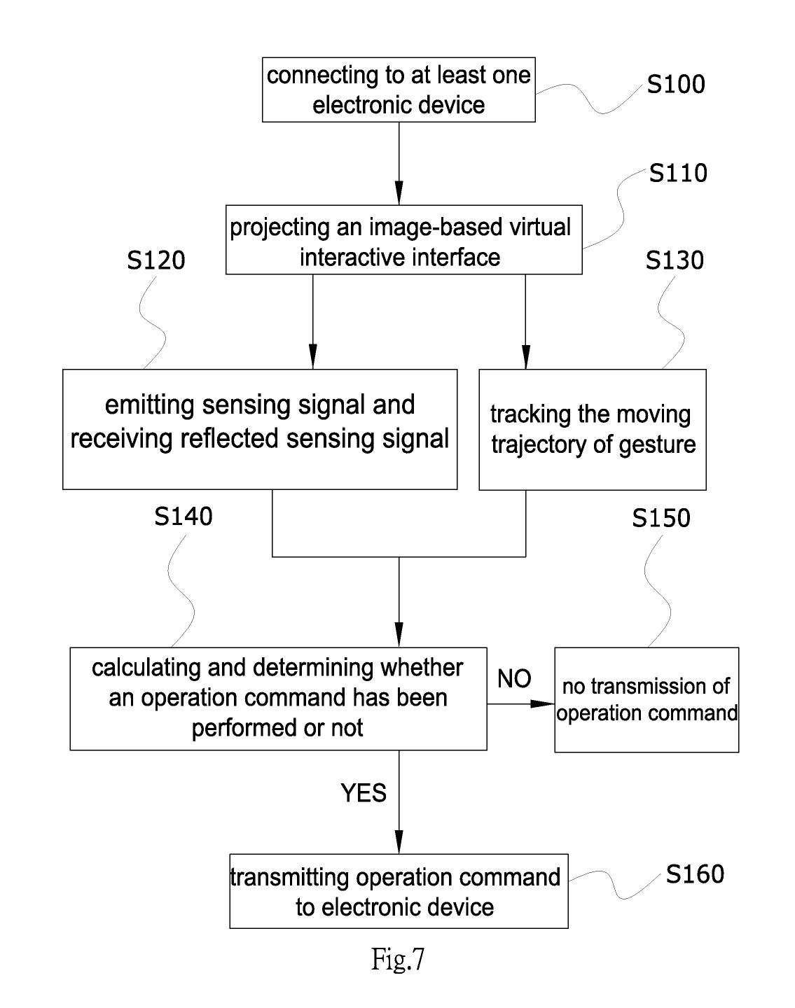

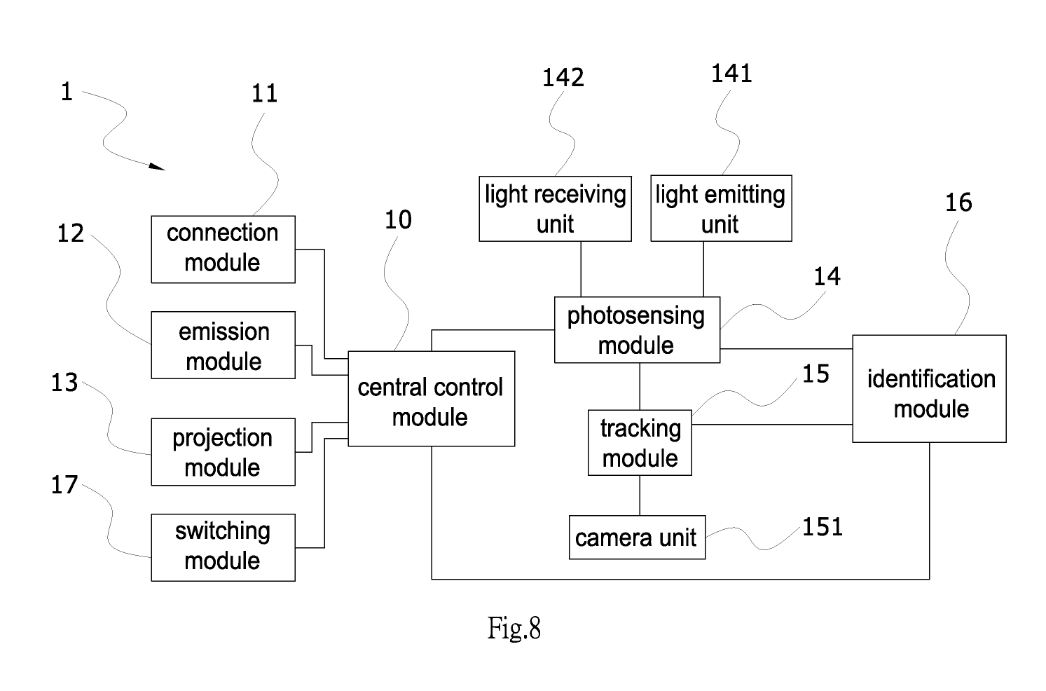

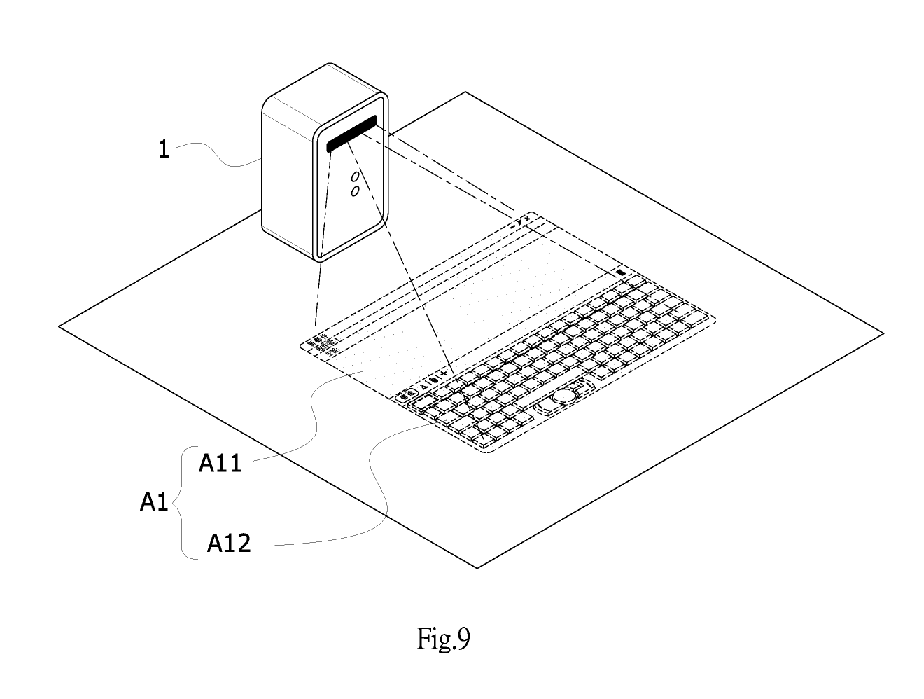

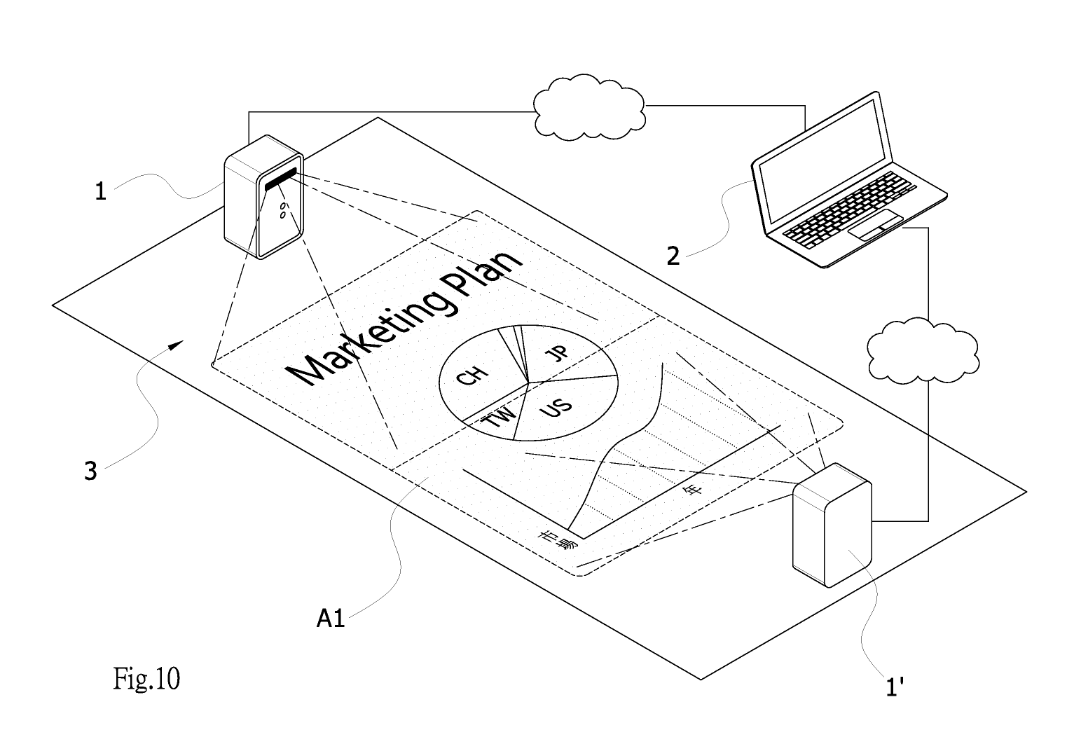

1. An image-based virtual interactive device, for users to perform human-computer interaction through gestures with at least one electronic device, comprising:
a central control module;
a connection module linked to said central control module for connecting said electronic device;
an emission module for emitting digital signals with said electronic device after the connection;
a projection module for projecting said digital signal to a physical plane so as to form an image-based virtual interactive interface;
a photosensing module having a light emitting unit and a light receiving unit, wherein said light emitting unit emits a plurality of sensing signal over said physical plane, while said light receiving unit receives reflected said sensing signals by said physical plane or said gesture;
a tracking module having at least one camera unit for tracking a moving trajectory of said gesture; and
an identification module for calculating a time lag between the emission and the reception of said sensing signal and said moving trajectory to determine whether an operating command has been performed or not.

2. The image-based virtual interactive device as claimed in claim 1, wherein said image-based virtual interactive interface is a virtual screen, a virtual keyboard, or a combination of both.

3. The image-based virtual interactive device as claimed in claim 1, wherein said central control module is connected to a switching module for switching to either said virtual screen, said virtual keyboard, or said combination of both.

4. The image-based virtual interactive device as claimed in claim 1, wherein said connection module is connected to said electronic device through either a wired or a wireless connection.

5. The image-based virtual interactive device as claimed in claim 1, wherein said sensing signal is either infrared light or laser light.

6. The image-based virtual interactive device as claimed in claim 1, wherein said light receiving unit is either a charge-coupled device or a CMOS photosensing component.

7. An implementing method of the image-based virtual interactive device, comprising the steps of:
operating an image-based virtual interactive device in such a wired or a wireless connection as to connect at least one electronic device to said image-based virtual interactive device;
projecting an image-based virtual interactive interface by a projection module of said image-based virtual interactive device above a physical plane;
emitting a plurality of sensing signals by a light emitting unit of said image-based virtual interactive device to the top of said physical plane, wherein said sensing signal is reflected when a user's gesture is within said image-based virtual interactive interface, and said reflected sensing signal is received by a light receiving unit;
tracking a moving trajectory of said gesture within said image-based virtual interactive interface by a camera unit of said image-based virtual interactive device;
calculating a time lag between the emission and the reception of said sensing signal and said moving trajectory and determining whether an operation command has been performed or not by an identification module of said image-based virtual interactive device; and
transmitting said operation command to said electronic device to drive corresponding application programs and perform actions.

8. The implementing method of the image-based virtual interactive device as claimed in claim 7, wherein a switching action can be performed after connecting said image-based virtual interactive device to said electronic device, so as to switch said image-based virtual interactive interface to a different display mode.

9. The implementing method of the image-based virtual interactive device as claimed in claim 8, wherein said image-based virtual interactive interface either a virtual screen, a virtual keyboard, or a combination of both.
